(19) United States
(12) Patent Application Publication
(10) Pub. No.: US 2003/0046333 A1
(43) Pub. Date: Mar. 6, 2003

(54) Recording request, development, reproduction and distribution acquisition system and method

(76) Inventors: Jason G. Jarman, Enumclaw, WA (US); Philip R. Griffin, Enumclaw, WA (US); Perry L. D'Armond, Buckley, WA (US); Jared W. Deveraux, Ravensdale, WA (US)

Correspondence Address: BLACK LOWE & GRAHAM, 816 SECOND AVE., SEATTLE, WA, 98104, US

(21) Appl. No.: 09/883,071

(22) Filed: Jun. 15, 2001

(51) Int. Cl. G06F 15/16

(52) U.S. Cl. 709/203; 709/217

(57) ABSTRACT

A method and system for receiving, developing, recording, transposing/arranging, and distributing personalized recordings. The system and method allow receiving requests for personalized recordings from a variety of sources, either directly or in-directly. The requests are then developed into personalized recordings either in-house or via a work for hire arrangement with outside artists. The developed requests are then recorded in a specified format, including genre, point of view, tempo and instrumental selection. Then the developed request is transposed/arranged into other genres, points of view, tempo and instrumental selections and added to the musical database. The recordings are then distributed, either via a distribution center or person to person. There also exists the ability to incorporate professional recording artists into the system to increase distribution network and audience base.

### FIELD OF THE INVENTION

This invention relates generally to the request, acquisition, development, reproduction, and distribution of personalized recordings.

### BACKGROUND OF THE INVENTION

The music industry has often tried to increase sales of the recordings they produce by recording songs that bring rise to certain emotional urges of the listener. More specifically songs have been generally written about the happiness of meeting a new person, discovering something new about one's self, or the general triumph of the human spirit. Likewise, songs have been written based upon general sad situations, for example, the end of a relationship, loss of a loved one, or other emotional situations. However, the songs that have been written are generally to a mass audience with no particular individual in mind. The result is the general public is only able to superficially associate themselves or their current situation with the song that is being sung. A system does not exist where personalized songs may be produced and sold to the public in an efficient manner.

Existing recording companies are focused on selling large quantities of a single recording to the general public. The albums are marketed and sold within a single genre and from a particular point of view. The songs are written to appeal generally to a wide range of listeners. This existing system is economically incapable of producing personalized recordings for individual sale or distribution. Small factions of recording artists have attempted to market their services as personalized songwriters. However, a myriad of problems and general inefficiencies have prohibited the success of such ventures.

The costs associated with writing, recording, and producing an individual song is very high. Having a song individually written and recorded for a specific occasion may cost several thousand dollars to produce. A significant expense is allocated to the time the artist spends in writing a specific song. Once the song is written, then the song must be recorded, produced and then distributed, each step requiring additional financial resources raising the overall cost of the single recording.

Yet another barrier to personalized musical recordings is the ownership of the produced material. Typically, a song is produced as a “work-for-hire,” which is a term of art in copyright law meaning the person paying for the work owns the rights in the work. Thus, when an artist produces a song, the artist has no right to make additional copies or derivative works of the recording. The artist only receives a single payment for the work completed without the ability to reproduce the work for additional financial gain. As such, the limited return for the effort required to produce a single use recording greatly deters artists from producing personalized recordings. The existing recording practices failure to control ownership rights yields two other significant problems.

First, the artist's inability to capitalize financially by selling multiple copies of the produced work is further accentuated by the artists inability to alter the point of view of the work to direct the meaning of the work toward alternative audiences. More specifically, if the work is a song written from a mother to a son, the audience is limited to people wanting recording written in that point of view. A much greater potential audience base is attainable if the song's point of view is adaptable in other directions, for example, mother-to-daughter, or husband to wife. However, no current recording artist or recording company is attacking personalized musical sales in this fashion.

Secondly, the initial genre in which the work is produced is only one of many potential genres and failing to employ all possible genres greatly limits the potential commercial exploitation of a single musical compilation. More specifically, nearly all recording artists are singular in the genre in which they will record their music. For example, county western singers rarely, if ever, record hip-hop music, metal, jazz, salsa or the blues. Thus, current recording practices are self-limiting by appealing to a very small section of the market.

Yet another problem with current personalized recording practices lies in the inability to hear what is being purchased before spending money. More specifically, there does not exist a system wherein people wishing to have a personalized recording produced for them can listen to the recording prior to it being produced or prior to purchasing the recorded work. The inability to listen to the recording prior purchasing increases the risk of customer dissatisfaction, thereby decreasing the probability of the purchase being made.

Another problem is the limited distribution system in which the current recording industry functions under. The large recording companies need only a single point of sale, for example large retail music stores. Alternatively, current personalized recording artists produce a single piece of music, incapable of being distributed through large outlet locations. There is no crossover between the two systems, as such, each entity is incapable of taking advantage of the increased market size associated with multiple distribution outlets.

The above stated problems with current musical recording practice all work in concert with one another to prohibit the production of personalized musical recordings. Consequently, there is an incredibly large market base not being serviced, for example, special events such as weddings and other social occasions. Additionally, the billion dollar markets associated with written personalized messages and greetings are all left without a means of efficiently producing recorded personalized messages and songs.

### SUMMARY OF THE INVENTION

A method and system for receiving, developing, recording, transposing/arranging and distributing personalized recordings is provided. The system receives requests for personalized recordings from a variety of sources, either directly or in-directly. The requests are developed into personalized recordings either in-house or via a work for hire arrangement with outside artists. The developed requests are recorded in a specified format, including genre, point of view, tempo and instrument selection then stored in a database. The developed request is transposed/arranged into other genres, points of view, tempo and instrumental selections and added to the database. The recordings are then distributed, either via a distribution center or person to person. There also exists the ability to incorporate professional recording artists into the system to increase distribution network and audience base.

In accordance with still further aspects of the invention, the genre is at least one of a new and old country, rock, blues, hip-hop, salsa, jazz, opera, soul, pop, easy listening, romance, swing, Latin, orchestral, adult contemporary, comedy, religious/gospel, or blues.

In accordance with still further aspects of the invention, the request is received via at least one of a person-to-person communication, direct mailing, Internet-based interaction, or telephonic or facsimile communication.

In accordance with still further aspects of the invention, the storing includes recording to at least one of an optical or magnetic recording medium, wherein the at least one of an optical or magnetic recording medium includes at least one of a compact disc, a mini-compact disc, an audio cassette, a record, a mp3 file, or a digital or analog recording device.

As will be readily appreciated from the foregoing summary, the invention provides a novel and unobvious method and apparatus for receiving, developing, transposing and distributing personalized recordings.

### BRIEF DESCRIPTION OF THE DRAWINGS

The preferred and alternative embodiments of the present invention are described in detail below with reference to the following drawings.

FIG. 1 is a system diagram of an aspect of the invention;

FIGS. 2 and 3 illustrate a flow chart of an aspect of this invention; and

FIG. 4 is a diagram of a personalized recording distribution aspect of this invention.

### DETAILED DESCRIPTION OF THE PREFERRED EMBODIMENT

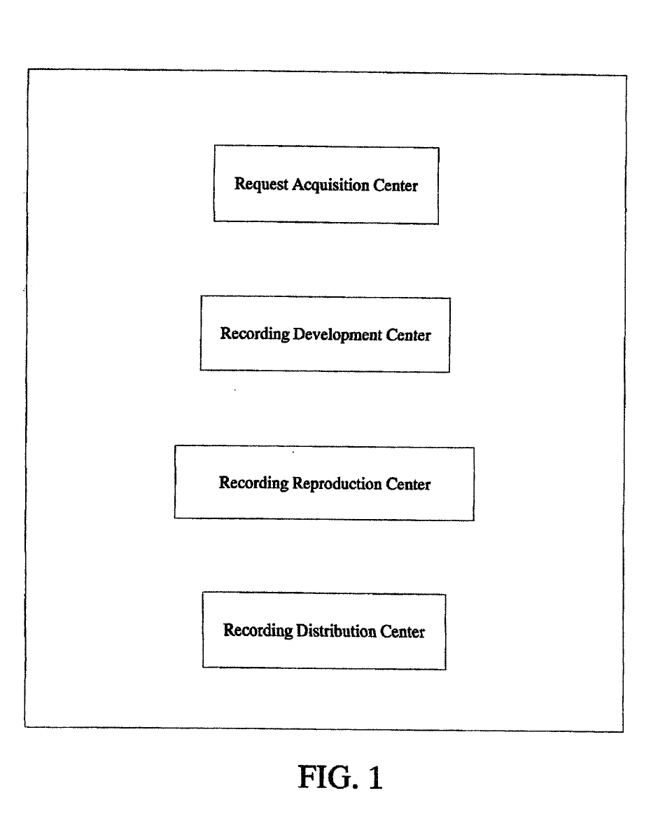

FIG. 1 is a diagram of a system 20 that allows for developing personalized recordings. The system 20, also called a production system, incorporates a plurality of different structures. However, the general internal structure of the production system 20 incorporates a request acquisition center 22, a recording development center 26, a recording reproduction center 28, and a recording distribution center 30.

The request acquisition center 22 provides the structure for receiving requests for personalized recordings. More specifically, a specific song selection is requested from a music database of personalized musical recordings. In the preferred embodiment, the request acquisition center 22 is a point of sale system, for example, a kiosk or retail store distribution. The point of sale system includes some form of user interface coupled to a microprocessor-based unit that allows customers to search a selection of musical recordings for a song or style of song they like from a stored library of songs. Other acquisition centers 22 are considered within the scope of this invention, for example, internet-based ordering systems, direct mail systems, other advertising mediums such as periodicals, newspapers, billboards, mailings, event planners and wedding planners.

The request acquisition center 22 serves as a receiving base for personalized musical requests. The requestor (customer) indicates the event style, genre and point of view of the song. The event style is any variety of events or occasions. For example, wedding, engagement, birthday, anniversary, graduation, divorce, death, religious holiday or Federal holiday are considered a few of the possible event styles encompassed within this invention. Next, the specific genre is requested, for example, new and old country, rock, blues, hip-hop, salsa, jazz, opera, soul, pop, easy listening, romance, swing, Latin, orchestral, adult contemporary, comedy, religious/gospel, or blues, etc. Finally, a specific point of view is selected for the personalized recording, for example, a song written from a mother to her son, a father to a daughter, husband to wife, grandparent to grandchild, or any other point of view giving rise to the need for the dedicated recording.

Following the request, the specific song selection enters a recording development center 26. The recording development center 26 is the area where the personalized recording is initially developed, including writing of lyrics and the accompanying music. In the preferred embodiment, music and lyrics are written by in-house musicians; however, other means may be incorporated without exceeding the scope of the invention. For example, independent artists may be employed to write a given song for a given occasion. Likewise, professional recording artists may also be employed by a license agreement or other contractual relationship to produce songs of a given nature. However, whether the music is produced in-house, with independent artists or professional recording artists, ownership of all copyrights and any other right in the recordings are maintained and wholly owned by the personalized song recording entity. Once the personalized song is created in the recording development center 26, the song is stored in a database while simultaneously the recording enters the recording reproduction center 28.

The recording reproduction center 28 is where the original requested song is recorded on a permanent medium for distribution to the customer. In the preferred embodiment, the recording is recorded on a compact disc. However, other recording mediums are considered within the scope of this invention, for example, mini compact disc, audiocassette, record, mp3, or other digital recording files. Upon completion of the requested recording, the recording is delivered to the client via the recording distribution center 30 discussed below.

The recording reproduction center 28 also functions as a song multiplier for the musical database. More specifically, the initial personalized song selected at the request acquisition center 22 is transposed/arranged into a great number of different songs that are added to the musical database. Initially, the single genre song is transposed/arranged into all other musical genres. Further, for each given genre a variety of different points of view for the recording are recorded. For example, husband to wife, father-in-law to son-in-law, etc. The recording reproduction center 26 alters the genre of the recording and/or the point of view from which the recording is taken. Likewise, within a single genre or within a single point of view the recording is adaptable to different tempos within the given genre to further increase the number of songs available in the musical database. Finally, the transposition/arrangement also includes altering the instrument that each song is recorded in. For example, a song is initially composed with various pieces such as piano, drums, and flutes. When the composed song is transposed/arranged other pieces (other types of instruments) are used in place of some or all of the original pieces. The transposition/arrangement produces songs in a multitude of genres, all of which are based on the same original song. The additional songs developed from the transposed/arranged original song are added to the musical database and are made available to purchasers at the acquisition center 22.

A recording distribution center 30 is also a part of the production system 20. The recording distribution center 30 takes a variety of forms. In the preferred embodiment, the recording distribution center 30 is a point of contact system. For example, stores, kiosks and what have you. However, other distribution forms are considered within the scope of this invention. For example, internet-based ordering systems, direct mail systems, and other advertising mediums such as periodicals, newspapers, billboards, mailings, etc. Further, it is within the scope of this invention that personalized recordings are sold through the distribution network of existing businesses. For example, songs recorded and sold in conjunction with personalized greeting cards, such as those produced by Hallmark® or other card producing companies. In this manner, a card for a specific occasion may be purchased, as well as for a nominal fee, a personalized recording. Additionally, distribution centers include event coordinators such as wedding and party planners, community event organizers, convention organizers, corporate marketing divisions and educational institutions.

In the preferred embodiment, all of the centers are located at the same place. In this manner, a single point of business is achieved. However, the various centers can be located at separate locations. For example, linking the acquisition 22 and distribution 30 centers to take advantage of similarities in operational requirements, likewise for the development 26 and reproduction centers 28.

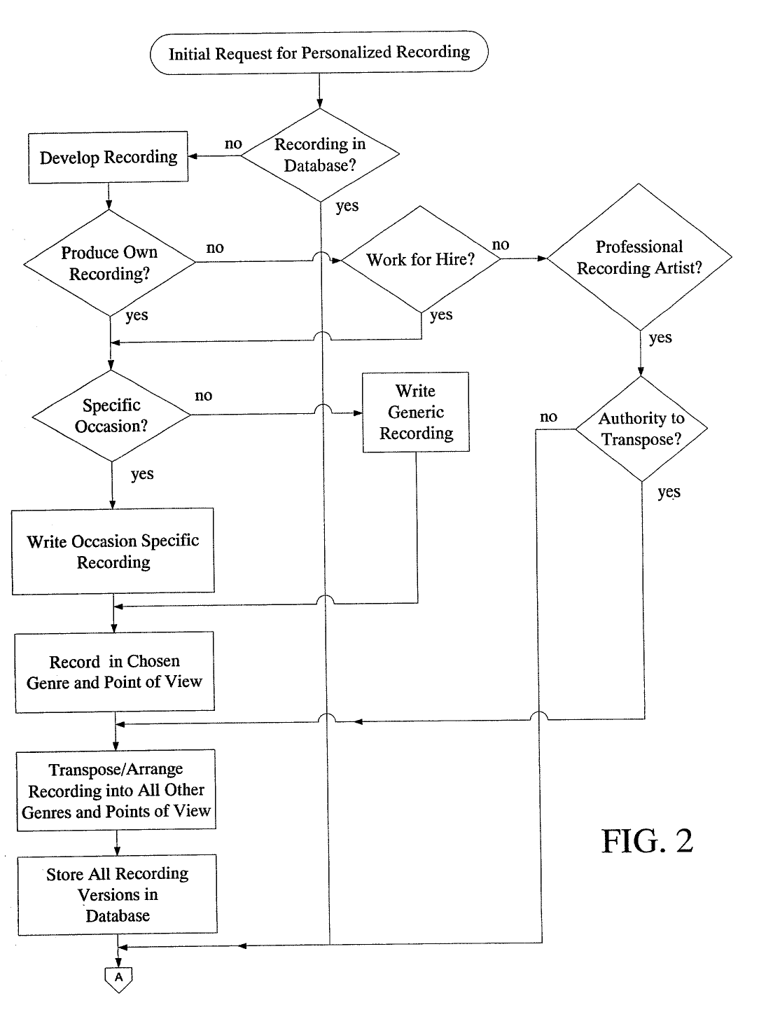

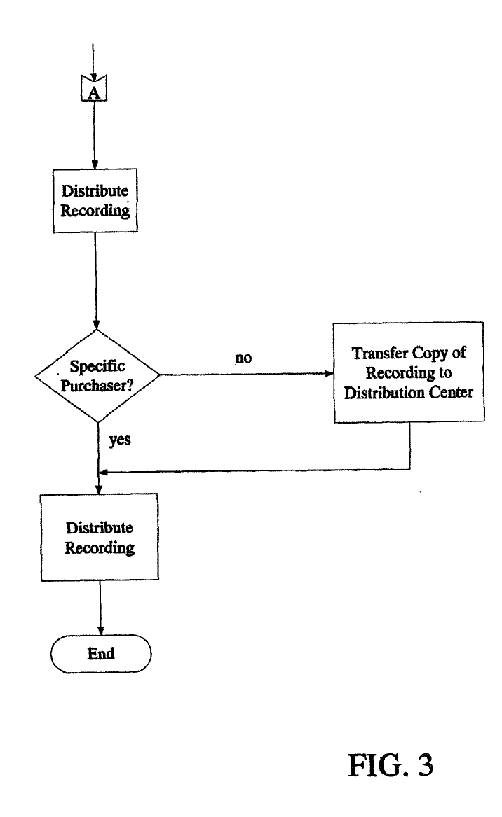

FIGS. 2 and 3 are flow charts representing the general process conducted by production system 20. As depicted in FIG. 2, and discussed above, the process begins with an initial request for a personalized song, as indicated in block 42. Initial requests may be at the point of sale, by mail, Internet, telephone, or any other communication medium by which an initial request may be communicated. Upon receiving the request, at block 44, a check is made to see if there is a song in the database that will meet the requirements of the request. More specifically, with point-of-sale requests, the requestor is allowed to sort through a collection of recordings and listen to full songs or audio samples of full songs. Additionally, if the request originates from cyberspace, it is anticipated that audio and lyrical samples may be downloaded for review. If the requestor finds a song that is acceptable, then the process steps forward to the distribution stage, see block 68, discussed in more detail below. However, in cases where an adequate recording does not exist, or where the request form, direct mailing for example, makes individual selection impossible, a song development process initiates as indicated by block 46.

When a more personalized song is required, or a song of a specific nature that is not in the database, then it becomes necessary to develop the song as illustrated by block 46. As discussed above, the development of a song may be done in a variety of ways. For example, the recording is produced in-house, as in block 48, or external musicians are employed to write specific songs, as in block 50, or in certain situations, professional recording artists are employable as represented by block 80, discussed in more detail below.

At decision block 48, the process determines whether the song is to be produced in-house or not. If the song is not to be produced in-house, the song will either be a work for hire arrangement, block 50, or a professional artist arrangement, block 80. If the decision is to either produce the recording in-house or employ a work for hire arrangement a determination is made regarding the specificity of the requested song. More specifically, at decision block 56, the process determines whether the song is to be written to a specific occasion, or a more generic one (a non-specific occasion). If the request is for a generic occasion, the process goes to block 58. If the request is for a specific occasion the process goes to block 60. For example, a song to celebrate a birthday is a generic personalized song while a song celebrating Pamela's 32 birthday from her mother is an example of a specific occasion song. The requested song is then recorded in the chosen style as indicated by block 62.

Regardless of whether a specific song or a generic song is initially written, blocks 60 and 58 respectively, the initial song is of a singular genre, point of view, instrumental choice and tempo. However, block 64 is where the singular song is transposed/arranged and thus multiplied into a great number of songs for the musical database. More specifically, as disclosed above, all facets of the original singular song are manipulated in order to produce numerous variations of the original song. Each “new” song is then stored in the music database as indicated by block 66. Further, as each song variation is developed and stored in the recording database, the songs are available for selection as part of decision block 44.

Referring to FIG. 3, distribution of the various musical recordings next occurs as indicated by block 68. As discussed above, the type of distribution performed is a function of the purchase type, as determined at decision block 70. More specifically, for a specific purchaser, block 72, the distribution is made at the time of the sale or upon completion of the requested song. However, in many situations, especially in the initial development of the market for personalized songs, the recording is transferred to the distribution center 30 as illustrated by block 74. In the preferred embodiment, the distribution center 30 is a retail store, for example a recording store equipped with recording preview capabilities. However, as discussed above, distribution is done by a variety of manners largely determined by the nature in which the recording was requested. For example, if there is a generic song that meets the purchaser's needs, the purchaser takes distribution of the song at the point of sale. However, if the purchaser is looking for a more personalized song, the purchaser places an order for the personalized songs at the point of sale. Songs will be produced and distributed through the point of purchase or other distribution devices such as direct mailing or electronic transfer. For example, personalized greetings may be shipped in conjunction with greeting cards, discussed in more detail below. At this point the process ends, as indicated by element 78.

Referring back to FIG. 2, in the instance where a professional artist is the source of the recording, as indicated by decision block 82, a slightly different process is followed. Largely, this invention functions to serve as a broader distribution network than is available, or is being employed by the recording industry. More specifically, musical releases by professional artists are distributed to the public through a greater network than just retail stores. More specifically, if the answer to the authority question of block 84 is negative, the professional artist still benefits from a very broad distribution network created by this unique system. However, if authority is granted to transpose the recording, the artist receives the benefit not only of the complex distribution network but also the exponential increase in market exposure by having a single initial recording crossing over into multi-genre based audiences.

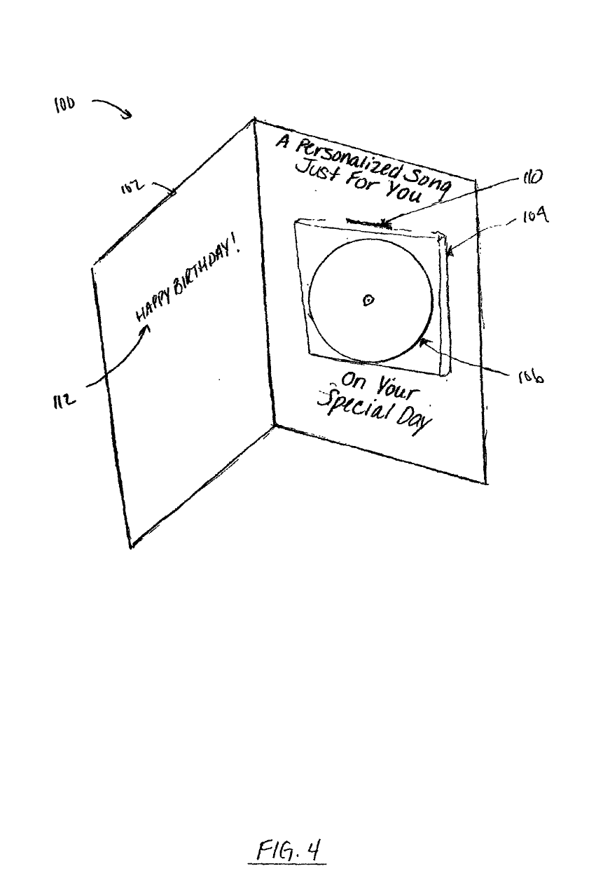

FIG. 4 depicts a distribution aspect of this invention. In one embodiment, a card delivery system 100 is employed. More specifically, the card delivery system 100 includes a card 102 with a written message 112, if included, is coupled with a recording medium 106. The recording medium 106 includes one ore more recorded songs. The one or more recorded songs are of the type described above. The songs are versions of a song specifically tailored for the theme of the card 102. Typically, an industry standard greeting card 102 is employed, however, other written instruments are considered within the scope of this invention, for example, invitations and announcements. Further as disclosed above, the recording medium 106 is preferably a compact disk (CD). However other recording mediums are within the scope of this invention, for example, optical or magnetic recording medium, wherein the optical or magnetic recording medium is a compact disc, a mini-compact disc, an audiocassette, a record, an mp3 file, or other digital or analog recording device.

The recording medium 106 is generally housed in either a rigid or non-rigid case 104, however, a case 104 is not required by this invention. The case 104 containing the recording medium 106, or in certain instances the recording medium 106 itself is coupled directly to the card 102. More specifically, the recording medium 106 is placed within the card 102, or alternatively, on the outside of the card 102. When coupled with the card 102, an attachment device 110 is employable to fix the recording medium 106 on the card 102. In the preferred embodiment a Velcro attachment is used. However, other attachment devices 110 are considered within the scope of this invention, for example, adhesives, magnets, elastic or other biasing devices. However, the recording medium 106 is also capable of being coupled with the card 102 without employing an attachment device 110. In this manner, the recording medium 106 is loosely coupled with the card 102. Once the desired card 102 and recording medium 106 are coupled, the combination is ready for distribution.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method of producing personalized recordings, comprising:
receiving a request from a requestor for a personalized recording;
developing a recording basis, in compliance with the request;
recording the developed recording basis to meet the request requirements;
transposing/arranging the recording into additional recordings;
storing all recordings in a music database; and
distributing the requested recording.

2. The method of claim 1, wherein receiving a request includes indicating at least one of a desired genre, a point of view, an instrument choice, and a tempo.

3. The method of claim 2, wherein the genre is at least one of new and old country, rock, blues, hip-hop, salsa, jazz, opera, soul, pop, easy listening, romance, swing, Latin, orchestral, adult contemporary, comedy, religious/gospel, or blues.

4. The method of claim 1, wherein developing the recording basis includes at least one of a lyrical or instrumental compositional creation.

5. The method of claim 1, wherein transposing/arranging the recording includes transposing/arranging at least one of a desired genre, a point of view, an instrument choice and a tempo.

6. The method of claim 1, wherein distributing the recording includes distributing to at least one of a distribution center or the individual requester.

7. The method of claim 1, wherein receiving a request includes receiving requests via at least one of a person-to-person communication, direct mailing, Internet-based interaction, telephonic or facsimile communication.

8. The method of claim 1, wherein recording further includes recording to at least one of an optical or magnetic recording medium, wherein the at least one of an optical or magnetic recording medium includes at least one of a compact disc, a mini-compact disc, an audio cassette, a record, a mp3 file, or digital or analog recording device.

9. A personalized recording, development and delivery device, comprising:
a request acquisition center configured to receive a request for a personalized recording;
a recording development center configured to develop the personalized recording;
a recording reproduction center configured to transpose/arrange and reproduce the personalized recording; and
a recording distribution center configured to distribute the personalized recording.

10. The device of claim 9, wherein the request acquisition center is a receiving unit for performing at least one of person-to-person communication, direct mailing, Internet-based interaction, or telephonic or facsimile communication.

11. The device of claim 9, wherein the recording development center is a lyrical and instrumental development system.

12. The device of claim 9, wherein the recording reproduction center is an analog or digital recording system.

13. The device of claim 9, wherein the recording reproduction center records to optical or magnetic recording medium, including compact disc, mini-compact disc, audiocassette, record, mp3 file, or digital or analog recording device.

14. The device of claim 9, wherein the recording distribution center is a system for distributing via a distribution center or to an individual requestor.

15. A method of producing personalized recordings, comprising:
a. generating an original recording for a specific occasion in a specific genre and tempo combination;
b. storing the specific recording in a recording database;
c. transposing/arranging the specific recording to a plurality of other genre and tempo combinations;
d. storing the plurality of transposed/arranged specific recordings in the recording database;
e. changing the point of view of the original recording into a plurality of other recordings having other points of view;
f. transposing/arranging the changed point of view recordings to a plurality of other genre and tempo combinations;
g. storing the changed point of view recordings in the recording database;
h. repeating steps e-g for other points of view from a list of points of view; and
i. making the stored songs available for purchase.

16. The method of claim 15, wherein the genre is at least one of a new and old country, rock, blues, hip-hop, salsa, jazz, opera, soul, pop, easy listening, romance, swing, Latin, orchestral, adult contemporary, comedy, religious/gospel, or blues.

17. The method of claim 15, wherein making the stored songs available for purchase comprises receiving requests via at least one of a person-to-person communication, direct mailing, Internet-based interaction, telephonic or facsimile communication.

18. The method of claim 15, wherein making the stored songs available for purchase comprises placing one of the stored recordings on a musical medium and coupling the musical medium with at least one of a greeting card, an invitation, or announcement.

19. A personalized recording system, comprising:
a. a means for receiving a request for a personalized recording for a specific occasion in a specific genre and tempo;
b. a means for generating the personalized recording from the request;
c. a means for storing the personalized recording to a database;
d. a means for transposing/arranging the personalized recording into other genres and tempos;
e. a means for storing the transposed/arranged recordings to the database;
f. a means for changing the point of view of the original recording;
g. a means for transposing/arranging the original recording into a plurality of other points of view;
h. a means for storing the transposed/arranged point of view recordings to the database;
i. a means for repeating e-g for other points of view from a list of points of view; and
j. a means for making the stored recordings available for purchase.

20. The system of claim 19, wherein the genre is at least one of a new and old country, rock, blues, hip-hop, salsa, jazz, opera, soul, pop, easy listening, romance, swing, Latin, orchestral, adult contemporary, comedy, religious/gospel, or blues.

21. The system of claim 19, wherein the means for making the stored songs available for purchase comprises a means for receiving requests via at least one of a person-to-person communication, direct mailing, Internet-based interaction, or telephonic or facsimile communication.

22. The system of claim 19, wherein the means for making the stored songs available for purchase comprises:
a. a means for placing one of the stored recordings on a recording medium; and
b. a means for coupling the musical medium with at least one of a greeting card, an invitation, or an announcement.

23. A method of commercially producing personalized recordings, comprising:
receiving a request for a personalized recording;
developing a recording basis in compliance with the request, including genre, point of view, instrumental choice and tempo;
recording the recording basis to meet the request requirements;
transposing/arranging the recording into additional recordings including altering the genre, point of view, instrumental choice and tempo of the recording to produce a plurality of recordings from the initial request;
storing all records in music database; and
distributing the recordings either to a specific purchaser or to a distribution center.

24. A personalized recording distribution system, comprising:
a written correspondence having a specific theme; and
a personalized recording coupled with the written correspondence wherein, the personalized recording and the written correspondence are of the same theme.

25. The personalized recording distribution system of claim 24, wherein the written correspondence is at least one of a greeting card, an announcement, or an invitation.

26. The personalized recording distribution system of claim 24, wherein the personalized recording is at least one of an optical or magnetic recording medium.

27. The personalized recording distribution system of claim 26, wherein the at least one of an optical or magnetic recording medium includes at least one of a compact disc, a mini-compact disc, an audio cassette, a record, a mp3 file, or digital or analog recording device.
